(19) United States
(12) Patent Application Publication
(10) Pub. No.: US 2026/0316178 A1
(43) Pub. Date: Oct. 15, 2026

(54) METHOD FOR FORMING STRONG AND DUCTILE JOINTS BETWEEN DISSIMILAR METALS AND APPLICATIONS OF SAME

(71) Applicant: NORTHWESTERN UNIVERSITY, Evanston, IL (US)

(72) Inventors: Samuel Grant Price, Evanston, IL (US); Zhaoxi Cao, Evanston, IL (US); Ian Daniel McCue, Evanston, IL (US)

(21) Appl. No.: 19/486,079

(22) PCT Filed: May 22, 2024
(86) PCT No.: PCT/US2024/030458

§ 371 Date: Nov. 20, 2025

Related U.S. Application Data
(60) Provisional application No. 63/468,127, filed on May 22, 2023.

(51) Int. Cl. B23K 20/233; B23K 103/18

(52) U.S. Cl. CPC B23K 20/233; B23K 2103/26

(57) ABSTRACT

A method of joining materials comprises providing an assembly comprising an interlayer sandwiched between first and second base materials to be joined, wherein the interlayer comprises at least two pre-liquid composition layers and at least one anchor layer alternatively disposed between the at least two pre-liquid composition layers; heating the assembly to a bonding temperature so that the at least two pre-liquid composition layers melt and form a liquid that is in equilibrium with terminal compositions of adjacent anchor layers; holding the heated assembly for sufficient time to allow a transient liquid phase reaction to occur and isothermally solidify therein, until the isothermal solidification has reached completion; and cooling the solidified assembly back to room temperature to achieve a robust joint between the base material and the second base material, without formation of deleterious phases, wherein the at least one anchor layer remains solid throughout the bonding process.

### CROSS-REFERENCE TO RELATED PATENT APPLICATION

This application claims priority to and the benefit of U.S. Provisional Patent Application Ser. No. 63/468,127, filed May 22, 2023, which is incorporated herein by reference in its entirety.

### FIELD OF THE INVENTION

The invention relates generally to materials, and more particularly, to a method for forming strong and ductile joints between dissimilar metals and applications of same.

### BACKGROUND OF THE INVENTION

The background description provided herein is for the purpose of generally presenting the context of the invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the invention.

Joining is a common process for any application involving multiple components. Transient liquid phase (TLP) bonding has been used to join two materials, where an interlayer foil is used. A common industry example is sandwiching a nickel foil (e.g., about 100 μm thick) between two pieces of titanium and heating up the joint. At elevated temperatures, Ni and Ti form a eutectic, which is a liquid that has a melting point below either of the base materials. This liquid helps form a strong interface between the two pieces of titanium, and then undergoes isothermal solidification as nickel diffuses into the Ti parts. The limitation of the TLP technique is that it only works for joining similar materials (i.e., titanium to titanium). A variation of TLP known as partial transient liquid phase bonding (PTLP) uses a “core layer” that remains solid during the bonding process. However, PTLP has only been used in the joining of ceramics and relies on elemental refractory core layers that just happen to work for the ceramic systems of interest.

Joining of dissimilar materials (specifically metals) is a challenging process that can lead to the formation of detrimental phases that embrittle the joint and lead to premature failure. For this reason, most dissimilar joints are made using mechanical fasteners and/or rivets. These joints are not desirable in aerospace (because they add weight) and small-scale electronics (because it is challenging to fabricate a screw at very small length scales).

Therefore, a heretofore unaddressed need exists in the art to address the aforementioned deficiencies and inadequacies.

### SUMMARY OF THE INVENTION

In one aspect, the invention relates to a method of joining materials. The method comprises providing an assembly comprising an interlayer sandwiched between a first base material and a second base material to be joined to each other, wherein the interlayer comprises at least two pre-liquid composition layers and at least one anchor layer alternatively disposed between the at least two pre-liquid composition layers; heating the assembly to a bonding temperature so that the at least two pre-liquid composition layers melt and form a liquid that is in equilibrium with terminal compositions of adjacent anchor layers; holding the heated assembly for sufficient time to allow a transient liquid phase (TLP) reaction to occur and isothermally solidify therein, until the isothermal solidification has reached completion; and cooling the solidified assembly back to room temperature to achieve a robust joint between the base material and the second base material, without formation of deleterious phases, wherein the at least one anchor layer remains solid throughout the bonding process.

In one embodiment, the first base material and the second base material are dissimilar to each other.

In one embodiment, said heating the assembly is performed under vacuum or inert atmosphere.

In one embodiment, the at least one anchor layer is joined to an adjacent anchor layer and/or the first and second base materials by the TLP reaction with the at least two pre-liquid composition layers.

In one embodiment, the at least one anchor layer is configured such that it operably diffuses with the first and second base materials to form a favorable composition gradient between the first and second base materials with high strength and no brittle phases.

In one embodiment, the at least one anchor layer comprises one of a graded anchor layer having a composition gradient along its thickness; a single anchor layer having a unform composition distribution along its thickness; and multiple discrete anchor layers, each of which comprises a distinct composition.

In one embodiment, each anchor layer is disposed between two adjacent pre-liquid composition layers.

In one embodiment, the first base material and the second base material are Ti and NiTi, respectively.

In one embodiment, each pre-liquid composition layer comprises Ni₃₀Ti₅₅Nb₁₅.

In one embodiment, the at least one anchor layer comprises one of a single anchor layer having a composition gradient from Ti₁₀Nb₉₀ to Ni₄₈Ti₄₀Nb₁₂; a single anchor layer of Nb₉₀Ti₁₀ having a unform composition distribution along its thickness; and a first anchor layer of Nb₉₀Ti₁₀, and a second anchor layer of Ni₄₈Ti₄₀Nb₁₂.

In one embodiment, the bonding temperature of about 1050° C.

In one embodiment, the first base material and the second base material are nitinol and Ti-64, respectively.

In one embodiment, the at least one anchor layer comprises a Nb anchor layer.

In one embodiment, the bonding temperature of about 1125° C.

In another aspect of the invention, the method of joining materials comprises determining a composition path from a composition of one of a first base material and a second base material to be joined to each other to that of the other of the first base material and the second base material that avoids brittle or non-solid phases; dividing the composition path into a series of segments such that a combination of phases along a segment is a subset of the phases present in the two end points of the segment; identifying an anchor region that is the collection of the segments excluding two segments that join to the first and second base materials, respectively, wherein the anchor region comprises at least one anchor layer, configured to form a favorable composition gradient between the first and second base materials; forming an assembly comprising an interlayer sandwiched between the first and second base materials, wherein the interlayer comprises at least two pre-liquid composition layers and the at least one anchor layer alternatively disposed between the at least two pre-liquid composition layers; and performing TLP bonding process on the assembly, during which a TLP reaction takes place joining the anchor layers to one another and the first and second base materials, thereby resulting in a joint with the favorable composition gradient and robust mechanical properties.

In one embodiment, the composition path is determined using thermodynamic calculations to predict thermodynamic equilibrium phases of compositions linking the composition of the one of the first base material and the second base material to that of the other of the first base material and the second base material, and identify the favorable composition gradient that yields the joint with high strength and no brittle phases.

In one embodiment, said determining the composition path is performed at an isothermal bonding temperature.

In one embodiment, the segments of the anchor region are fabricated as solid layers and joined together via the TLP reaction.

In one embodiment, the compositions between adjacent anchor layers reside in phase regions that are adjacent to regions with the same set of phases plus a common liquid phase.

In one embodiment, each segment end point is made into an individual anchor layer of that single composition, and in between anchors are a layer of the composition corresponding the common liquid phase for the given anchor layer pair.

In one embodiment, a single anchor layer of the entire gradient of the anchor region is used, and on either side of it is a layer whose composition corresponds to the liquid common between the anchor region endpoint and the corresponding base material composition.

In one embodiment, the at least one anchor layer comprises one of a graded anchor layer having a composition gradient along its thickness; a single anchor layer having a unform composition distribution along its thickness; and multiple discrete anchor layers, each of which comprises a distinct composition.

In one embodiment, each anchor layer is disposed between two adjacent pre-liquid composition layers.

In one embodiment, said performing the TLP bonding process on the assembly comprises eating the assembly to a bonding temperature so that the at least two pre-liquid composition layers melt and form a liquid that is in equilibrium with terminal compositions of adjacent anchor layers; holding the heated assembly for sufficient time to allow a TLP reaction to occur and isothermally solidify therein, until the isothermal solidification has reached completion; and cooling the solidified assembly back to room temperature to achieve a robust joint between the base material and the second base material, without formation of deleterious phases, herein the at least one anchor layer remains solid throughout the TLP bonding process.

In yet another, the invention relates to an article comprising at least one joint of the first and second materials fabricated by the method as disclosed above.

These and other aspects of the invention will become apparent from the following description of the preferred embodiment taken in conjunction with the following drawings, although variations and modifications therein may be affected without departing from the spirit and scope of the novel concepts of the invention.

### BRIEF DESCRIPTION OF THE DRAWINGS

The following drawings form part of the present specification and are included to further demonstrate certain aspects of the invention. The invention may be better understood by reference to one or more of these drawings in combination with the detailed description of specific embodiments presented herein. The drawings described below are for illustration purposes only. The drawings are not intended to limit the scope of the present teachings in any way.

FIGS. 1A-1C show respectively three schematical bonding schemes for dissimilar joining according to embodiments of the invention.

FIGS. 2A-2B show respectively (FIG. 2A) a successful bonding which is free of intermetallics or porosity and (FIG. 2B) a poor joint riddled with intermetallics due to a lack of composition control.

FIGS. 3A-3E shows various bonding schemes. FIG. 3A shows a ternary phase diagram. FIG. 3B shows an unsuccessful bonding for joining Ti to NiTi in the Ni—Ti—Nb system at 1050° C. FIGS. 3C-3E show successful bonding for joining Ti to NiTi in the Ni—Ti—Nb system at 1050° C. Traditional TLP bonding is not viable for joining NiTi to Ti, as the brittle NiTi₂ phase lies on the tie-line between the two base materials Ti and NiTi. FIG. 3B illustrates a state-of-the-art transient liquid phase bonding process. In this process, an “interlayer foil” of Ni₃₀Ti₅₅Nb₁₅ is placed between two pieces of different metals. Upon heating to an elevated temperature (1050° C.) the foil melts, and then solidifies. Unfortunately, due to its phase stability, a brittle phase is formed upon cooling. That is, if TLP bonding is attempted without a solid anchor layer to guide the composition, the brittle NiTi₂ intermetallic will form. FIGS. 3C-3E depict three embodiments of the anchor-layer assisted bonding approach according to the invention. In FIG. 3C, a single anchor layer including a gradient in composition from Ti₁₀Nb₉₀ to Ni₄₈Ti₄₀Nb₁₂ is joined to the two base alloys with a pre-liquid composition of Ni₃₀Ti₅₅Nb₁₅. In FIG. 3D, two separate anchor layers are used of compositions Ti₁₀Nb₉₀ and Ni₄₈Ti₄₀Nb₁₂, respectively. These are joined to each other and the base alloys with pre-liquid layers of Ni₃₀Ti₅₅Nb₁₅. Depending on the alloy system, multiple anchor layers may be utilized at distinct compositions. In FIG. 3E, a single “spatially tailored” interlayer foil is used to carry out bonding. Upon heating, the gray regions of Ni₃₀Ti₅₅Nb₁₅ melt, but the Nb₉₀Ti₁₀ “anchor layer” remains solid, and prevents brittle phase formation. The general strategy according to the invention is to use a solid phase that is in equilibrium with the liquid to suppress any new phases from forming.

FIGS. 4A-4C show a strategy generalized to any dissimilar joining scenario, using the following computational schemes. FIG. 4A: a grid-based A* path planning algorithm finds the initial route in composition space connecting the starting point and ending point. A* preferentially chooses to explore nodes likely to provide the shortest route to the target. It finds a path rapidly but explores relatively few nodes along the way. FIG. 4B: more points are sampled around the initial path but are constrained to be within a specified distance of path and in the same phase region. These extra points provide the leeway necessary for further optimization of the path using a continuous-space RRT* algorithm (FIG. 4C). The cost function of the RRT* is such that it minimizes the number of nodes used and maximizes the distance to the bad phase regions. An additional constraint is applied to ensure that the phases found along an edge are a subset of the phases present at the two nodes that edge connects. The nodes of this final path, excluding the two endpoints, correspond to the compositions of the required anchor layers. Note that this path is also “coastal”, meaning that the path lies in phases regions that are adjacent to phase regions that contain liquid (blue regions). Thus, its phases will be the first to form during solidification from the transient liquid.

FIG. 5 shows (a) low-magnification electron micrograph of the 2 hr NiTi—Ti bond using Ni—Ti—Nb MPD, with the top right showing a high-magnification image of the Ti—Nb interface, and higher magnification (b) Nb—Ti and (c) NiTi—Nb interfaces. No intermetallics or voids are observed in these regions.

FIG. 6 shows nanoindentation results across the NiTi/Nb/Ti joint. Mapping results for: (top) the Ti/Nb interface, and (bottom) the NiTi/Nb interface. For both interfaces, the joint region is the middle of the figures, extending 5-10 μm. The results here highlight that the joint has a high efficiency, exceeding 100% at the NiTi/Nb interface and exceeding 70% on the Ti/Nb interface.

FIG. 7 shows a compositional path from Ni₅₃Cr₂₃Fe₁₈Nb₃Mo₂Ti₁ (approximation of Inconel 718) and NiTi, where (top) the elemental composition is plotted as a function of normalized distance along the path and shows large, transient increases in Cr, Mo, and Nb; (bottom) the plot of equilibrium phases shows the intermediate presence of BCC_B2 #1 and no bad phases. This gradient path can be used to determine an anchor layer and transient liquid that will produce a high-quality joint.

FIG. 8 shows schematically a bonding scheme used for determining a composition path between two dissimilar base materials according to embodiments of the invention.

FIGS. 9A-9C show schematically a path planning framework to determine the composition path according to embodiments of the invention.

FIG. 10 shows schematically how anchor phases are designed from a path generated using the path planning framework according to one embodiment of the invention.

FIG. 11 shows schematically how anchor phases are designed from a path generated using the path planning framework according to another embodiment of the invention.

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

As used herein, “around”, “about”, “substantially” or “approximately” shall generally mean within 20 percent, preferably within 10 percent, and more preferably within 5 percent of a given value or range. Numerical quantities given herein are approximate, meaning that the term “around”, “about” “substantially” or “approximately” can be inferred if not expressly stated.

As used in the disclosure, the term “base alloy (material)” refers to one of the alloys (materials) to be joined. The term “phase region” refers to a connected region of compositions that correspond to the same set of equilibrium phases, i.e., a distinct region on the phase diagram. The term “pre-liquid composition (layer)” refers to a composition (layer) that is solid at room temperature, but which will be liquid at the bonding temperature. The term “anchor layer” refers to a layer that remains solid throughout the bonding process, helping to anchor the composition of the final gradient.

In addition, all compositions used in the exemplary embodiments of the disclosure are in atomic percent unless otherwise specified.

As used in the disclosure, the phrase “at least one of A, B, and C” should be construed to mean a logical (A or B or C), using a non-exclusive logical OR. As used herein, the term “and/or” includes any and all combinations of one or more of the associated listed items.

Embodiments of the invention are illustrated in detail hereinafter with reference to accompanying drawings. The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in different order (or concurrently) without altering the principles of the invention.

In view of the aforementioned deficiencies and inadequacies, one of the objectives of this invention is to provide a method of joining dissimilar materials, e.g., nickel to titanium, without the formation of deleterious (brittle) phases. The novel method also utilizes the transient liquid phase (TLP) bonding process to carry out dissimilar joining but uses a solid phase that is in equilibrium with the liquid to suppress any new phases from forming. Specifically, this method uses an interlayer foil, with its composition tailored throughout its thickness, that suppresses the formation of deleterious phases that would otherwise nucleate and grow. In addition to suppressing these phases, the reaction kinetics of the technology is orders of magnitude faster than current state of the art.

According to the invention, the method can be used for joining of dissimilar materials. This is accomplished by examining phase equilibria in multi-compositional dimensions (e.g., 5 or 6 elemental dimensions). In some embodiments, it starts with determining compositions that are in chemical equilibria with the material to be joined, while also having a transient liquid. These compositions need to be customized for each side of the joint (i.e., the two different materials). Upon heating, a transient liquid forms on either side of the joint and completes a bond without the formation of deleterious phases.

According to the invention, an inverse design approach is used, beginning with the determination of a final composition gradient that yields a successful joint. In dissimilar joining such a composition gradient is unavoidable and so the joining process must be carefully designed to arrive at a favorable gradient. The primary requirement is that the thermodynamically stable states of the compositions along the gradient correspond to solid phases that are not brittle (i.e., not intermetallics). Other relevant requirements on the properties of the gradient, such as coefficient of thermal expansion mismatch, conductivity, etc., may be imposed as well, so long as they can be estimated quickly from computational data.

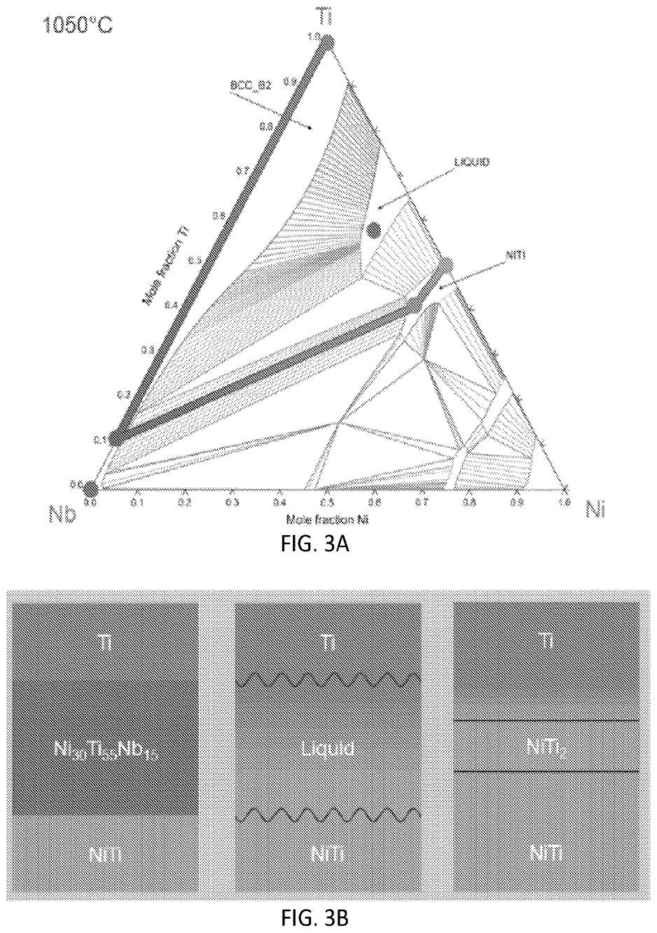

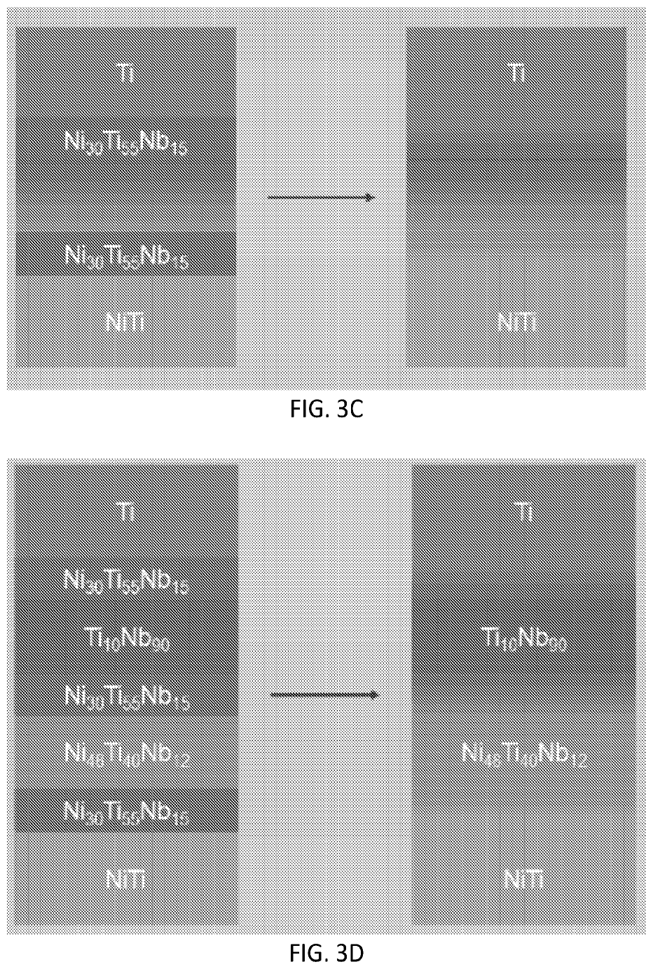

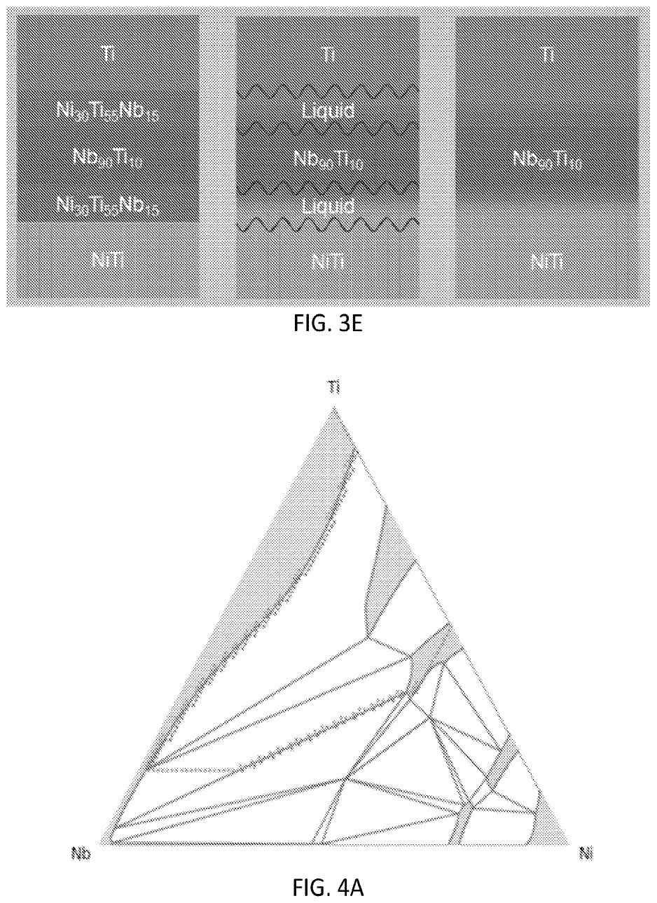

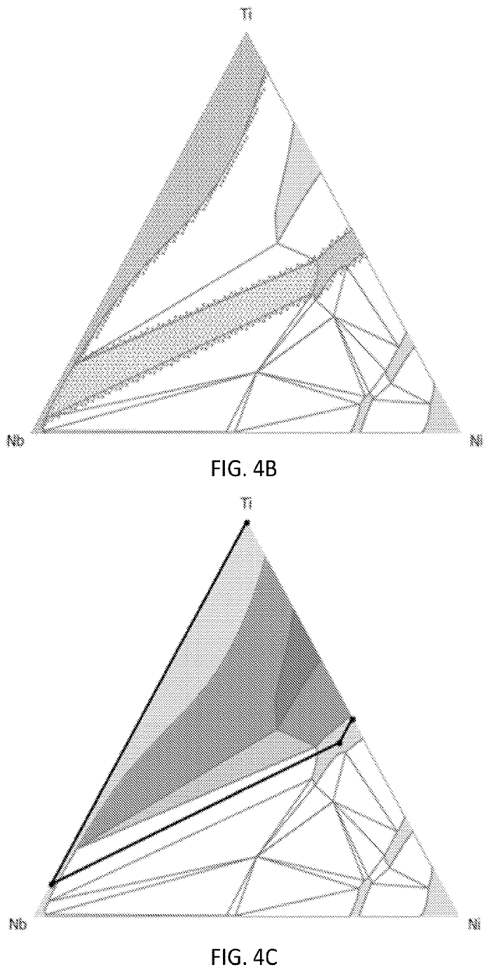

According to the invention, CALculation of PHAse Diagrams (CALPHAD) software is used to predict the thermodynamic equilibrium phases of compositions linking the composition of one of the base alloys to the other. An algorithm is employed to determine a composition path from one base alloy composition to the other that avoids brittle or non-solid phases. These calculations are performed at the isothermal bonding temperature. The composition path is then divided up into a series of segments, such that, the combination of phases along a segment is a subset of the phases present in the two end points of the segment. The collection of these segments excluding the two segments which join to the base alloys makes up the anchor region. The anchor region segments can then be fabricated as solid layers and joined together via a TLP reaction. The number of anchors layers used is flexible and depends on the nature of the specific system. However, it is required that the compositions between adjacent anchor layers reside in phase regions that are adjacent to regions with the same set of phases plus a common liquid phase. At one extreme, each segment end point can be made into an individual anchor layer of that single composition. In between anchors are a layer of the composition corresponding the common liquid phase for the given anchor layer pair. One exemplary embodiment of the extreme is shown in FIG. 3D. At the other extreme, a single anchor layer of the entire gradient of the anchor region is used. On either side of it is a layer whose composition corresponds to the liquid common between the anchor region endpoint and the base alloy composition. One exemplary embodiment of the other extreme is shown in FIG. 3E. Any compromise between these two extremes is also a plausible interlayer setup. One exemplary embodiment of this is shown in FIG. 3C. The interlayer is then placed between the two alloys to be joined, heated to the bonding temperature, held there for sufficient time to allow the TLP reactions to occur and isothermally solidify, and then the assembly is cooled back down.

According to the invention, the novel approach is used for bonding dissimilar metal alloys using an interlayer composed of alternating anchor layers and pre-liquid layers. A design strategy is introduced wherein a favorable composition gradient is identified using thermodynamic calculations, then divided into point/segments of composition that make up the anchor layers which remain solid throughout the bonding process. Pre-liquid compositions are placed in between adjacent anchor layers; when heated to the bonding temperature, these pre-liquid composition layers melt and form a liquid that is in equilibrium with the terminal compositions of the adjacent anchor layers. A transient liquid phase reaction then takes place joining the anchor layers to one another and the two base alloys. The result is a joint with a favorable composition gradient and therefore good mechanical properties.

More broadly, fusion and solid-state joining techniques often rely on an interlayer to improve joint performance between dissimilar materials. Thus, the novel approach is applicable to any joining strategy. Furthermore, functional path planning is beneficial to any layer-by-layer processes (e.g., additive manufacturing and deposition).

Without intent to limit the scope of the invention, exemplary embodiments of the invention are given below.

In some embodiments, the method comprises providing an assembly comprising an interlayer sandwiched between a first base material and a second base material to be joined to each other. In some embodiments, the first base material and the second base material are dissimilar to each other. In some examples, the first base material and the second base material are two different metal alloys.

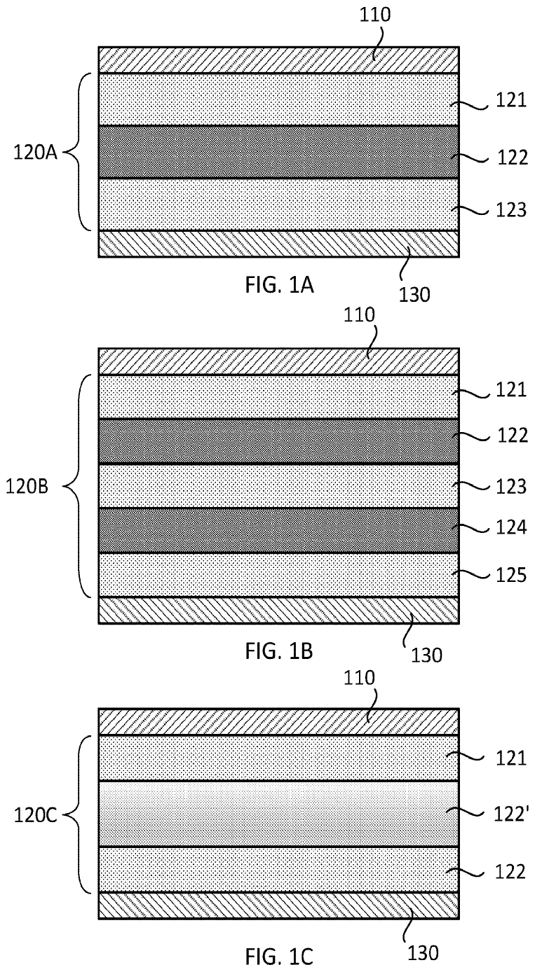

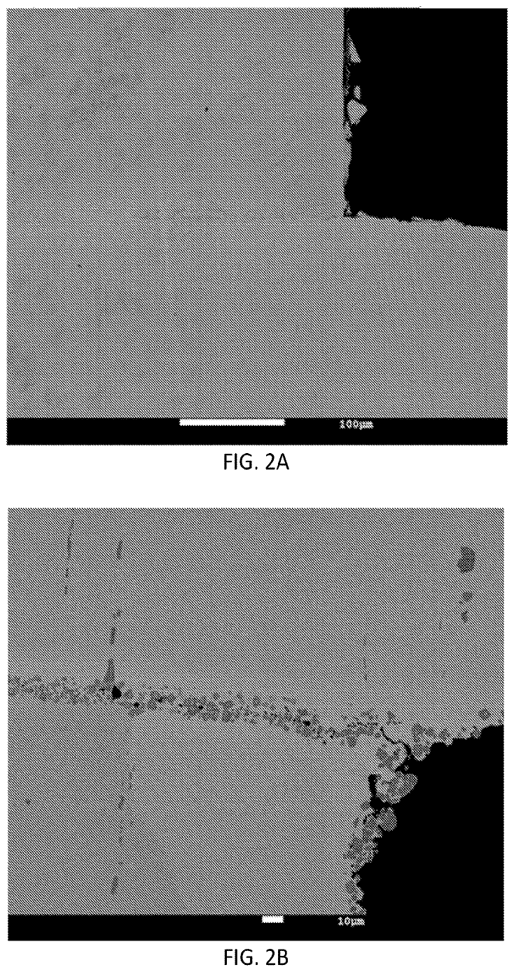

Referring to FIGS. 1A-1C, the assembly is schematically shown according to embodiments of the invention. The assembly includes an interlayer 120A/120B/120C sandwiched between the first base material 110 and the second base material 130.

As shown in FIG. 1A, the interlayer 120A comprises two pre-liquid composition layers 121 and 123 and one anchor layer 122 placed between the two pre-liquid composition layers 121 and 123. The anchor layer 122 has a unform composition distribution along its thickness.

As shown in FIG. 1B, the interlayer 120B comprises three pre-liquid composition layers 121, 123 and 125 and two anchor layers 122 and 124. The anchor layer 122 is placed between the pre-liquid composition layers 121 and 123, while the anchor layer 124 is placed between the pre-liquid composition layers 123 and 125. Each anchor layer 122/124 has a distinct composition with a unform composition distribution along its thickness.

As shown in FIG. 1C, the interlayer 120C comprises two pre-liquid composition layers 121 and 123 and one anchor layer 122′ placed between the two pre-liquid composition layers 121 and 123. The anchor layer 122′ is a graded anchor layer having a composition gradient along its thickness.

The method further comprises heating the assembly to a bonding temperature so that the at least two pre-liquid composition layers melt and form a liquid that is in equilibrium with terminal compositions of adjacent anchor layers; holding the heated assembly for sufficient time to allow a TLP reaction to occur and isothermally solidify therein, until the isothermal solidification has reached completion; and cooling the solidified assembly back to room temperature to achieve a robust joint between the base material and the second base material, without formation of deleterious phases, wherein the at least one anchor layer remains solid throughout the bonding process.

In some embodiments, said heating the assembly is performed under vacuum or inert atmosphere.

In some embodiments, the at least one anchor layer is joined to an adjacent anchor layer and/or the first and second base materials by the TLP reaction with the at least two pre-liquid composition layers.

In some embodiments, the at least one anchor layer is configured such that it operably diffuses with the first and second base materials to form a favorable composition gradient between the first and second base materials with high strength and no brittle phases.

In some embodiments, the first base material and the second base material are Ti and NiTi, respectively.

In some embodiments, each pre-liquid composition layer comprises Ni₃₀Ti₅₅Nb₁₅.

In some embodiments, the at least one anchor layer comprises one of a single anchor layer having a composition gradient from Ti₁₀Nb₉₀ to Ni₄₈Ti₄₀Nb₁₂; a single anchor layer of Nb₉₀Ti₁₀ having a unform composition distribution along its thickness; and a first anchor layer of Nb₉₀Ti₁₀, and a second anchor layer of Ni₄₈Ti₄₀Nb₁₂.

In some embodiments, the bonding temperature of about 1050° C.

In some embodiments, the first base material and the second base material are nitinol and Ti-64, respectively.

In some embodiments, the at least one anchor layer comprises a Nb anchor layer.

In some embodiments, the bonding temperature of about 1125° C.

In some embodiments, the method of joining materials comprises determining a composition path from a composition of one of a first base material and a second base material to be joined to each other to that of the other of the first base material and the second base material that avoids brittle or non-solid phases; dividing the composition path into a series of segments such that a combination of phases along a segment is a subset of the phases present in the two end points of the segment; identifying an anchor region that is the collection of the segments excluding two segments that join to the first and second base materials, respectively, wherein the anchor region comprises at least one anchor layer, configured to form a favorable composition gradient between the first and second base materials; forming an assembly comprising an interlayer sandwiched between the first and second base materials, wherein the interlayer comprises at least two pre-liquid composition layers and the at least one anchor layer alternatively disposed between the at least two pre-liquid composition layers; and performing TLP bonding process on the assembly, during which a TLP reaction takes place joining the anchor layers to one another and the first and second base materials, thereby resulting in a joint with the favorable composition gradient and robust mechanical properties.

In some embodiments, the composition path is determined using thermodynamic calculations to predict thermodynamic equilibrium phases of compositions linking the composition of the one of the first base material and the second base material to that of the other of the first base material and the second base material, and identify the favorable composition gradient that yields the joint with high strength and no brittle phases.

In some embodiments, said determining the composition path is performed at an isothermal bonding temperature.

In some embodiments, the segments of the anchor region are fabricated as solid layers and joined together via the TLP reaction.

In some embodiments, the compositions between adjacent anchor layers reside in phase regions that are adjacent to regions with the same set of phases plus a common liquid phase.

In some embodiments, each segment end point is made into an individual anchor layer of that single composition, and in between anchors are a layer of the composition corresponding the common liquid phase for the given anchor layer pair.

In some embodiments, a single anchor layer of the entire gradient of the anchor region is used, and on either side of it is a layer whose composition corresponds to the liquid common between the anchor region endpoint and the corresponding base material composition.

In some embodiments, the at least one anchor layer comprises one of a graded anchor layer having a composition gradient along its thickness; a single anchor layer having a unform composition distribution along its thickness; and multiple discrete anchor layers, each of which comprises a distinct composition.

In some embodiments, each anchor layer is disposed between two adjacent pre-liquid composition layers.

In some embodiments, said performing the TLP bonding process on the assembly comprises eating the assembly to a bonding temperature so that the at least two pre-liquid composition layers melt and form a liquid that is in equilibrium with terminal compositions of adjacent anchor layers; holding the heated assembly for sufficient time to allow a TLP reaction to occur and isothermally solidify therein, until the isothermal solidification has reached completion; and cooling the solidified assembly back to room temperature to achieve a robust joint between the base material and the second base material, without formation of deleterious phases, herein the at least one anchor layer remains solid throughout the TLP bonding process.

The invention in some embodiments also relates to an article comprising at least one joint of the first and second materials fabricated by the method as disclosed above.

These and other aspects of the invention are further described below. Without intent to limit the scope of the invention, exemplary instruments, apparatus, methods, and their related results according to the embodiments of the invention are given below. Note that titles or subtitles may be used in the examples for convenience of a reader, which in no way should limit the scope of the invention. Moreover, certain theories are proposed and disclosed herein; however, in no way they, whether they are right or wrong, should limit the scope of the invention so long as the invention is practiced according to the invention without regard for any particular theory or scheme of action.

### Example 1

### Ti—NiTi Joint with Single Gradient Anchor Layer

In this example, an interlayer is assembled and positioned between the Ti and NiTi parts as shown in FIG. 3C. The anchor layer includes a composition gradient from Ti₁₀Nb₉₀ to Ni₄₈Ti₄₀Nb₁₂. Several methods of fabricating the interlayer are possible, including, but not limited to, magnetron sputtering, powder pastes or cold spraying. The pre-liquid layers are of the same composition (Ni₃₀Ti₅₅Nb₁₅) and may be mechanically attached to the anchor layer or separate. The bonding process is initiated by heating the assembly under vacuum or inert atmosphere to the bonding temperature of 1050° C. Upon heating, the pre-liquid compositions liquify and wet the surfaces of the anchor layer and the base alloy, filling in any surface asperities. In the upper region, Ti from the liquid region diffuses into the anchor layer, while Ni and Nb diffuses from the liquid region into the solid Ti base alloy. Solidification of a Nb-rich BCC phase begins from the upper face of the anchor layer, while solidification of a Ti-rich BCC structure occurs from the face of the Ti-base alloy. These proceed, while the composition of the liquid shifts so significantly that it arrives in a region that corresponds to a fully solid BCC phase. Meanwhile in the lower region, Ni, Ti, and Nb diffuse from the liquid into the anchor layer. Some Ni also diffuse into the NiTi base alloy. However, solidification largely occurs on the lower face of the anchor layer. This proceeds until isothermal solidification have reached completion. Extended annealing after this point encourages solid-state diffuse and smooth out gradients in composition. Once solidified the assembly can be cooled back to room temperature having achieved a robust joint between the Ti and NiTi parts, which is free of deleterious phases.

### Example 2

### Ti—NiTi Joint with Multiple Anchor Layers

Depending on the alloy system, multiple anchor layers may be utilized at distinct compositions. The purpose of multiple anchors is to prevent mixing between compositions on either side of the anchor that may lead to deleterious phase formation. As shown in FIG. 3D, two separate anchor layers are used of compositions Ti₁₀Nb₉₀ and Ni₄₈Ti₄₀Nb₁₂, respectively. The pre-liquid can either be deposited in advance on the two anchor layers or attached in a method provided in the previous example. The bonding process is initiated by heating the assembly under vacuum or inert atmosphere to a bonding temperature between 1050° C. and 1120° C. Upon heating, the pre-liquid compositions liquify and wet the surfaces of the two anchor layers and the respective base alloys. In the upper region, Nb and Ni diffuse from the liquid region, into the Ti base alloy, and solidification of a Ti-rich BCC alloy occurs from the Ti-base alloy to the Ti₁₀Nb₉₀ anchor layer. In the middle region, Ti diffuses from the liquid region into both the Ti₁₀Nb₉₀ and Ni₄₈Ti₄₀Nb₁₂ anchor layers. Solidification of dual phase Ni-rich and Nb-rich BCC alloys occurs from the Ni₄₈Ti₄₀Nb₁₂ anchor layer to the Ti₁₀Nb₉₀ anchor layer. In the lower region, Ti diffuses from the liquid into the anchor layer and the NiTi base alloy. Solidification of a Ni₄₈Ti₄₀Nb₁₂ phase occurs from the Ni₄₈Ti₄₀Nb₁₂ anchor phase. Once solidified the assembly can be cooled back to room temperature having achieved a robust joint between the Ti and NiTi parts, which is free of deleterious phases.

### Example 3

### Ti—NiTi Joint with Single Spatially Tailored Interlayer Foil

FIG. 3E shows an exemplary embodiment of which a single “spatially tailored” interlayer foil is used to carry out bonding. Upon heating, the regions of Ni₃₀Ti₅₅Nb₁₅ melt, but the anchor layer of Nb₉₀Ti₁₀ remains solid, and prevents brittle phase formation.

### Example 4

### Similar and Dissimilar Joining of Nitinol Through TLP Bonding

Nitinol, a near-equiatomic nickel-titanium alloy, is one of the most widely used shape memory alloys (SMAs) due to its excellent mechanical behavior, corrosion resistance, and large recoverable strain limit (about 8%). For these reasons, nitinol has been fielded in many aerospace applications, including self-deploying actuators, folding aircraft wings, and rover tires. However, these applications require joining nitinol to support structures which are often a different alloy class. Traditional welding methods, when applied to nitinol, lead to the formation of brittle intermetallic phases, reduced strength within the joint region, and decreased functional performance (such as recoverable strain and heterogeneous transformation temperatures). Thus, dissimilar joining of nitinol remains a grand challenge in the ultimate use of these materials, and advances in joining technologies will greatly expand the potential applications of SMAs.

In this example, TLP bonding is examined in place of traditional fusion or mechanical joining. TLP bonding is a diffusion-based joining process that involves creating a liquid interlayer at the joint interface by heating the materials to a suitable temperature. Unlike brazing—where a liquid forms between the two base metals and is subsequently quenched—TLP solidifies by holding the joint at this elevated for an extended period (hours). During this isothermal hold, elements from the liquid interlayer diffuse into the base metals and a solidification front slowly propagates into the liquid region, consuming the liquid. This slow solidification process minimizes void formation, producing a strong and tough joint, and does not substantially alter the composition of the base materials. Owing to these benefits, TLP is used in aerospace to join Ni-base superalloy turbine blades and has been demonstrated in similar bonding of nitinol.

Despite the beneficial properties of TLP joints, it is nearly impossible to apply this technique to dissimilar bonding. The presence of a liquid leads to rapid diffusion between the base metals, which can lead to brittle phase formation or one side of the joint dissolving during long isothermal holds. To address these issues, the invention discloses an anchor-assisted dissimilar TLP bonding method wherein an “anchor layer” is introduced between the two materials. This anchor is chosen such that it diffuses with the base metals to form a favorable concentration gradient (high strength, no brittle phases). In this example, the anchor-assisted dissimilar TLP bonding method is applied to dissimilar joining of nitinol and Ti-64.

Bonding experiments were conducted on small nitinol and Ti cubes (4×4×4 mm³). To minimize bonding times, 1-2 μm thick TLP interlayers (Ni₃₅Ti₆₅Nb₅) were fabricated via magnetron sputtering on polished nitinol and Ti substrates prior to bonding. To hold the samples in place during bonding, the cubes were clamped in custom Ti-64 holders, which ensured physical contact while applying no direct pressure. The samples and holder were sealed in quartz tubes, and then heated at 1125° C. for 1-12 hours. We compared similar bonding (NiTi/NiTi, and Ti/Ti) as well as dissimilar bonding (NiTi/Ti); for the dissimilar bond, a Nb anchor layer was used. After bonding, the joints were mechanically polished and characterized using scanning electron microscopy (SEM), energy-dispersive X-ray spectroscopy (EDS), and nanoindentation.

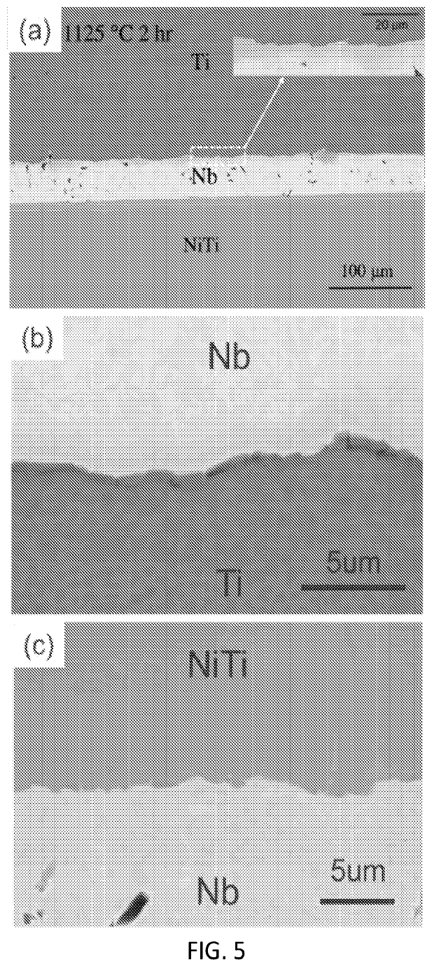

FIG. 5 highlights the quality of the dissimilar NiTi/Ti joint using a Nb anchor. The overall joint, panel (a), has a sharp transition from Ti-to-Nb-to-NiTi. EDS mapping and analysis of the Nb/Ti interface, panel (b), indicates no deleterious phase formation—in agreement with the equilibrium Ti—Nb phase diagram. Some small cracks/voids are observed in panel (b), which could be attributed to either polishing artifacts or thermal expansion strains during quenching after bonding. The NiTi/Nb interface, panel (c), exhibits little-to-no Ti₂Ni intermetallic formation; traditional joining processes report that Ti₂Ni is difficult to avoid.

However, the bonding temperature in these experiments is above the melting point of Ti₂Ni, and thus deleterious phases should not form provided the entire liquid region solidifies prior to quenching. A commercial Nb foil was used for these experiments, but a thinner foil could be prepared to produce a gradient rather than a discrete layer of Nb.

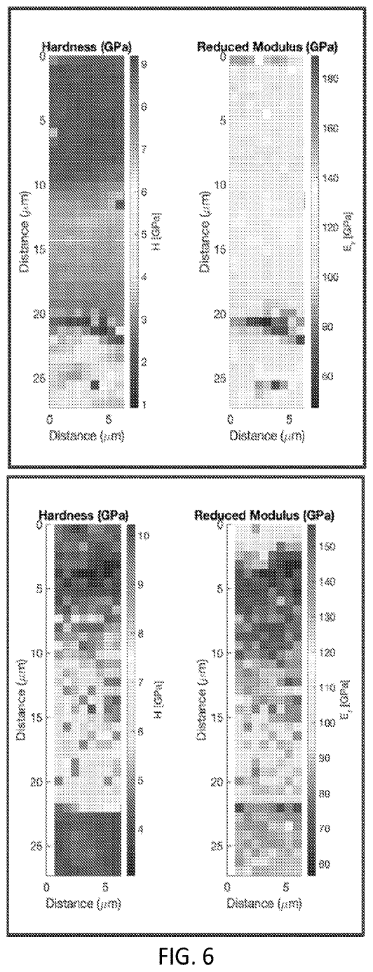

Nanoindentation results across the interfaces shown in FIG. 6 indicate excellent joint efficiencies. For the Ti/Nb interface, the elastic moduli of the two materials are similar and the joint has a higher hardness than the Nb anchor; there is a horizontal band of low hardness and moduli, which are attributed to different step heights from uneven polishing. For the NiTi/Nb interface, the joint region has higher hardness and moduli values than both nitinol and Nb. These enhanced properties are due to the solidified joint region, consisting of a NiTi/Nb eutectic structure, which improves the mechanical strength. It is expected that the anchor layer properties could be further enhanced via cold working or selecting a composition that has precipitates.

The exemplary study demonstrates that a Nb anchor layer can be introduced into a NiTi/Nb joint to form a strong bond without deleterious phase formation. The hardness maps across the NiTi—Nb and Ti—Nb interfaces show a continuous hardness profile for both Ti/Nb and NiTi/nb interfaces, which leads to a more uniform macroscopic response during mechanical loading. The hardness values at the NiTi/Nb two phase region are approximately 1 GPa harder than the substrate NiTi. Isothermal solidification of the liquid interlayer was completed within 2 hours, which indicates the process can be scaled for practical application.

### Example 5

### A Novel Path Planning Framework for Constructing Compositional Gradients in Many-Element Systems

SMAs have found widespread use in superelastic components and as compact, lightweight actuators. However, current use cases require SMAs to be joined to structural alloys (e.g., Al7075, Inconel 718, 316L). At present, this is done mechanically (e.g., bolting or crimping) adding significant weight and volume, which reduces the benefit of using an SMA. Attempts at metallurgical bonds, which would not incur the weight/volume penalties of mechanical joints, have fallen short, often producing joints with deleterious phases and poor joint efficiencies (defined as σⱼₒᵢₙₜ/σₘₐₜₑᵣᵢₐₗ). This is largely because the elemental composition and phase structure of SMAs are highly dissimilar to nearly all structural alloys. As a result, most of the possible composition gradients connecting the SMA to the structural alloy led to the formation of undesirable phases, typically brittle intermetallics. Thus, for a metallurgical joint to be successful, it must have a final composition gradient that results in favorable (strong, ductile) phases, while avoiding unfavorable (weak, brittle) ones. To make such a joint two components are required: (1) a target final gradient that is known (or predicted) to be favorable; and (2) a technique for guiding the joining process to such a targeted final gradient. This example focuses on developing the former.

Previous work has made use of path planning algorithms from the field of robotics to quickly generate paths in composition spaces, which with the aid of CALculation of PHAse Diagrams (CALPHAD) software, avoid unfavorable phases while also minimizing a particular cost function (distance to bad phases, CTE mismatch, etc.). These approaches, though powerful, require surrogate models of the unfavorable phase regions prior to path planning, necessitating extensive sampling of CALPHAD before path construction can even begin. These methods are feasible for low order systems (i.e., ternaries and quaternaries) but are not practical for higher order systems (more than 4 elements) which are often needed when planning a gradient between an SMA and a complex structural alloy.

The approach to effectively find paths in higher order systems is to directly couple the CALPHAD sampling and the path planning processes, allowing the information gleaned from one sample (single equilibrium calculation) to inform the choice of subsequent samples. Informed sampling reduces the total number of data points that must be collected before a feasible path can be found. The time needed to query CALPHAD is on the order of 1 second, and thus dominates over all other calculations in the path planning process. As a result, the time needed for path planning is set by the time needed to sample CALPHAD, and by extension the number of CALPHAD queries required. Surrogate models can reduce the number of CALPHAD queries after they are constructed but require upfront blanket sampling of CALPHAD to be built. This makes them an efficient approach for low dimensions but one that scales poorly to higher dimensions. In one example, the number of samples required goes as 5*10^{d} where d is the number of elements. In our approach we forgo the surrogate model and instead sample CALPHAD on the fly to determine whether compositions are favorable or unfavorable. While this approach goes against current trends in the literature, we demonstrate its effectiveness in higher-order systems by using it to construct a path from Inconel 718, modeled as Ni₅₃Cr₂₃Fe₁₈Nb₃Mo₂Ti₁, to NiTi while avoiding all “bad” phases (those which are not FCC, BCC, or HCP).

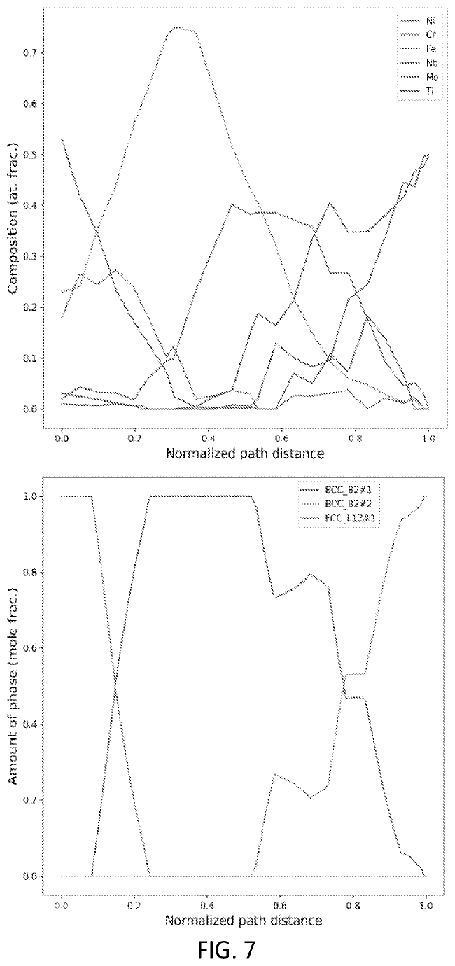

FIG. 7 shows the compositional path planned from Ni₅₃Cr₂₃Fe₁₈Nb₃Mo₂Ti₁ to NiTi at 1380K. The path was constructed using a rapidly expanding random tree (RRT) algorithm with on-the-fly CALPHAD calculations using Thermo-Calc and the TCHEA5.1 database. In total, only 31,340 single equilibrium calculation queries were made to Thermo-Calc, orders of magnitude fewer than the 10⁵-10⁷ queries that would be required with traditional upfront sampling schemes. Assuming surrogate model construction requires 5*10^{d} CALPHAD calculations (with d=6 in this system) and that the queries take one second each, our approach would take 8.7 hours while the surrogate model approach would span 58 days! Our method can also be used to optimize any cost function that can be calculated on a point-wise basis (e.g., CTE mismatch, chemical potential gradient).

The exemplary study demonstrates that a concurrent path planning and CALPHAD sampling algorithm can give excellent performance in higher order systems, rapidly finding feasible paths with very few queries to CALPHAD by using it to construct a path from Inconel 718 to NiTi with just 31,340 CALPHAD queries. This approach has often been overlooked, likely because surrogate modelling is more effective in lower-order systems. With this method gradients from NiTi and other SMAs can be made to a variety of structural alloys that avoid deleterious phases, making strong lightweight metallurgical joints possible.

### Example 6

### Efficient Path Planning for Dissimilar Joining

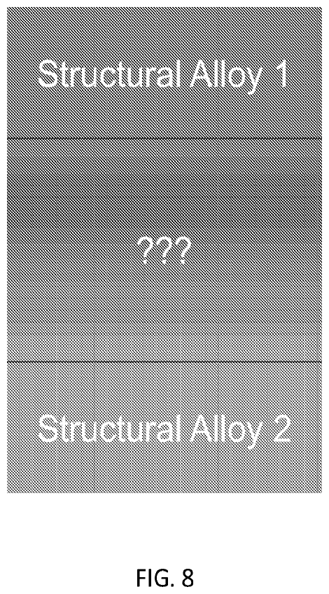

According to the invention, the method of joining dissimilar materials utilizes a solid phase that is in equilibrium with the liquid to suppress any new phases from forming. It starts with determining compositions that are in chemical equilibria with the material to be joined, while also having a transient liquid. These compositions need to be customized for each side of the joint (i.e., the two different materials). Specifically, an inverse design approach is used, beginning with the determination of paths in composition space with “good” equilibrium phases, e.g., FCC, BCC, HCP, without intermetallics and/or liquids. In some embodiments, as shown in FIG. 8, the composition path can be determined from a composition of Structural Alloy 1 to that of Structural Alloy 2 that avoids brittle or non-solid phases, which is used to determine a favorable composition gradient between Structural Alloy 1 and Structural Alloy 2, for yielding a successful joint. The primary requirement is that the thermodynamically stable states of the compositions along the gradient correspond to solid phases that are not brittle (i.e., not intermetallics).

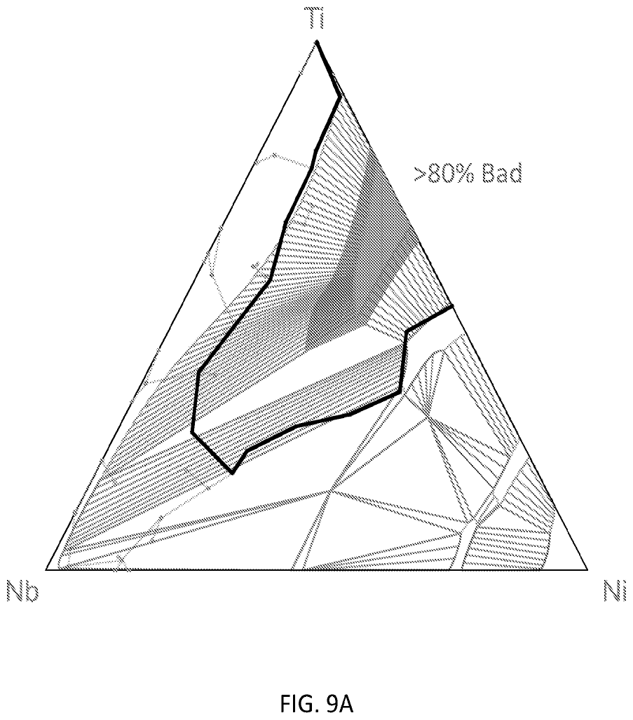

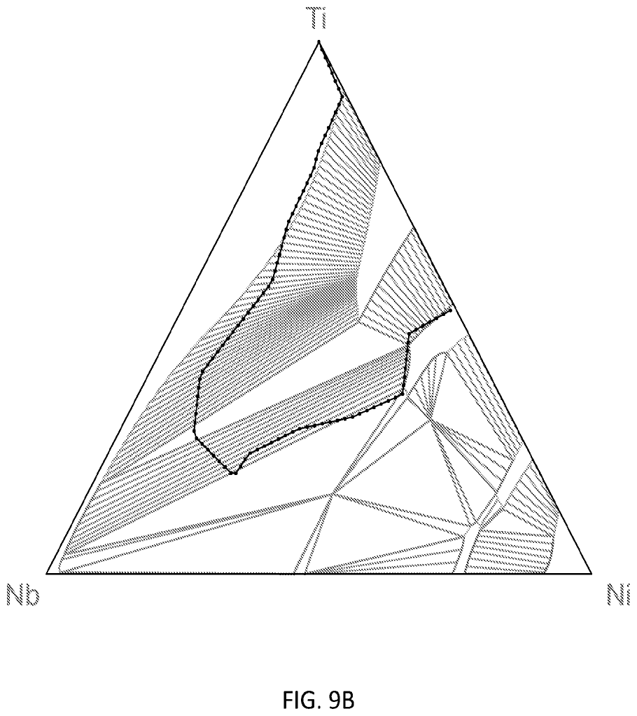

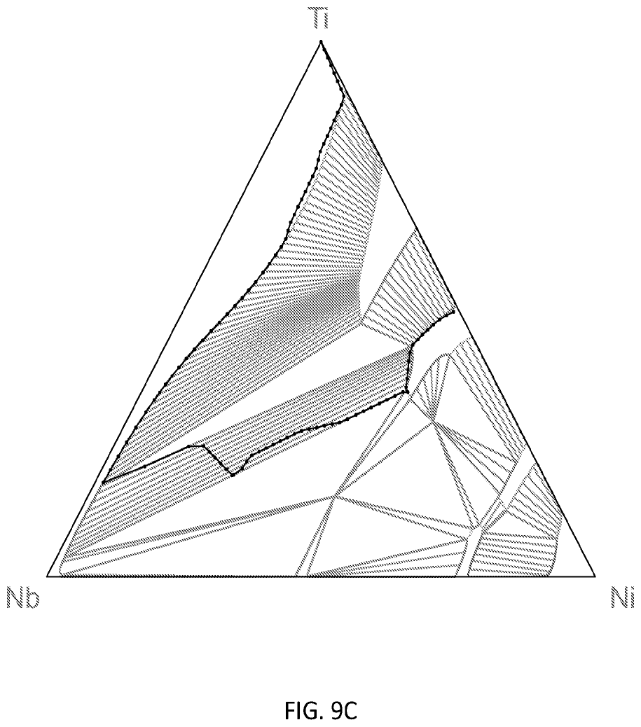

It may be difficult (time-consuming) to find a gradient in high-dimensions that has strictly no “bad” phases, i.e., brittle intermetallics and liquids. This is because the requirement of absolutely zero “bad” phase greatly constricts the viable space which is known to reduce the efficiency of the RRT algorithm, making path planning slow. To alleviate this, the constraint is partially relaxed by allowing some fraction of bad phases in the initial path, as shown in FIG. 9A. The RRT will be able to find a path much more rapidly now that the feasible space is larger.

The ultimate goal is still to construct a path with no bad phases and so we have developed a theorem relating the relaxed constraint path that is quick to determine with the RRT to the final path that satisfies the strict constraint (zero bad phases). The theorem states that given an isothermal path in composition space from a given start point to a given end point such that all of the points along the path are not entirely bad (i.e., have less 100% total bad phase) then there exists a different path between those same start and end points that consists of only good phases (as long as the start and end points are 100% good). Not only does this theorem prove the existence of such a path but it also provides a formula to compute the new (entirely good) path from the old (partially bad) one without the need for any further CALPHAD queries.

The mathematical relationship for the path transformation is as follows:

$${σ}^{*} ( α ) = {[ \frac{1}{( {H}_{1} ( σ ( α ) ) \cdot {V}_{g o o d} )} ( {H}_{1} ( σ ( α ) ) ⊙ {V}_{g o o d} ) ]}^{T} {H}_{2} ( σ ( α ) )$$

wherein σ is the composition of the original path parameterized by α, the distance along the path (0=start, 1=finish); σ* is composition of the transformed path with only ductile phases; V_{good} is the “good phase vector” (column vector of S×1, where S is the number of total distinct phases in the system) consisting of 1's in the rows corresponding to good phases and 0's in the rows corresponding to bad phases; and H₁ is a function that gives the fraction of phases at a given global composition (maps global composition to S×1 vector); and H₂ is a function that gives the composition of the individual phases at a given global composition (maps global composition to S×d matrix where d is the number of elements in the system).

This transformation is applied pointwise, so the path/gradient is first discretized as shown in FIG. 9B.

Then the above formula is applied to each point to shift the path from partially bad regions to entirely good regions, as shown in FIG. 9C. The phase fractions (H₁) and phase compositions (H₂) for each point on the original path are known from the CALPHAD calculations performed on them.

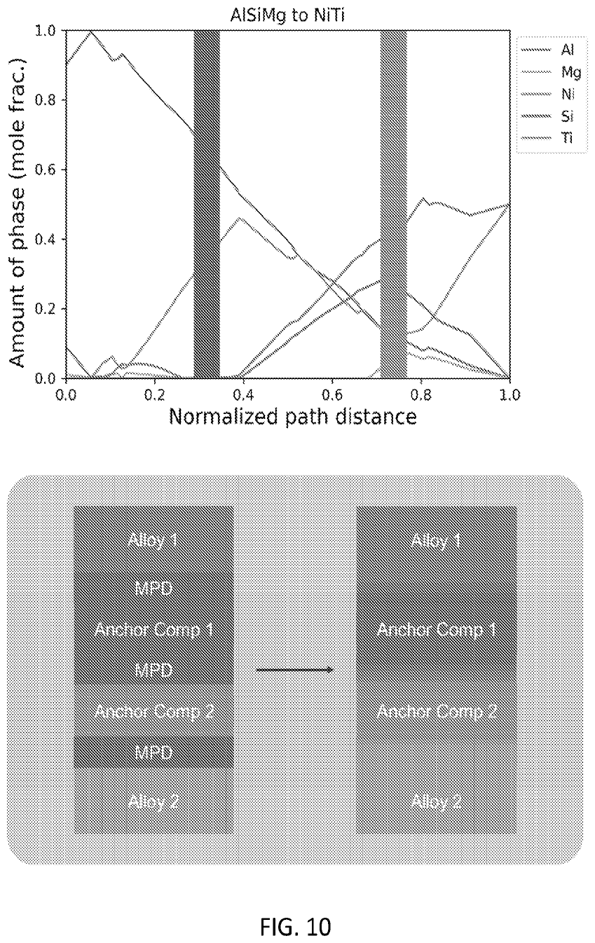

FIG. 10 illustrates how anchor layer compositions are designed from a path generated using the above framework in one embodiment of the invention. Discrete compositions are selected to serve as anchor layer compositions which represent a minimum in free energy and chemical potential gradient. A suitable melting point depressant (MPD) composition is chosen for each pre-liquid layer and a TLP reaction is carried out to join the anchor layers and base alloys together.

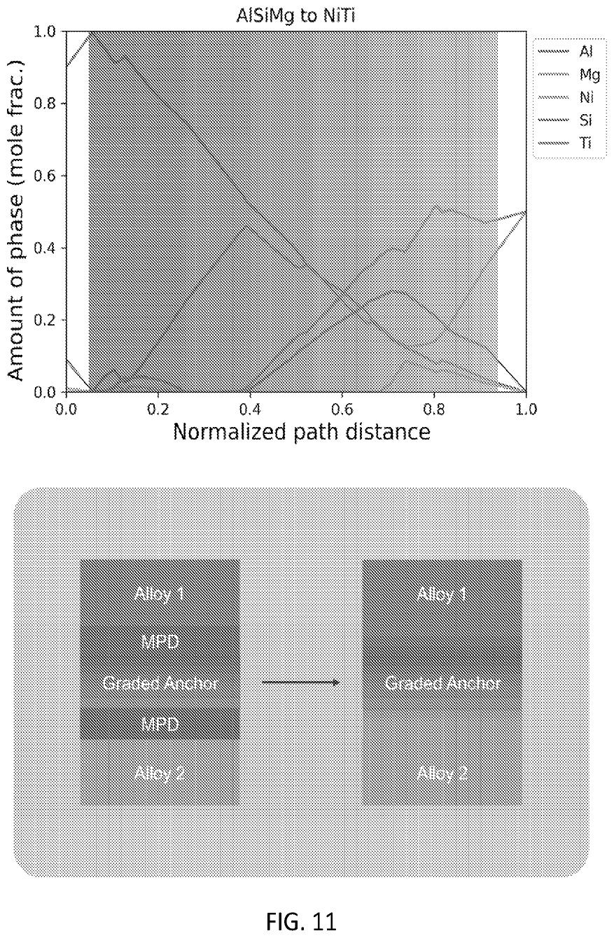

In another embodiment, as shown in FIG. 11, a favorable gradient using the previous framework can be directly fabricated and serve as a graded anchor layer in a TLP reaction that bonds the ends of this anchor layer to the two alloys of interest.

In sum, the invention discloses an approach for bonding dissimilar metal alloys using an interlayer composed of alternating anchor layers and pre-liquid layers. A design strategy is introduced wherein a favorable composition gradient is identified using thermodynamic calculations, then divided into point/segments of composition that make up the anchor layers which remain solid throughout the bonding process. Pre-liquid compositions are placed in between adjacent anchor layers; when heated to the bonding temperature, these layers melt and form a liquid that is in equilibrium with the terminal compositions of the adjacent anchor layers. A transient liquid phase reaction then takes place joining the anchor layers to one another and the two base alloys. The result is a joint with a favorable composition gradient and therefore good mechanical properties.

The foregoing description of the exemplary embodiments of the present invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

Some references, which may include patents, patent applications, and various publications, are cited and discussed in the description of this invention. The citation and/or discussion of such references is provided merely to clarify the description of the invention and is not an admission that any such reference is “prior art” to the invention described herein. All references cited and discussed in this specification are incorporated herein by reference in their entireties and to the same extent as if each reference was individually incorporated by reference.

### LIST OF REFERENCES

[1]. D. Grummon, K.-B. Low, J. Foltz and J. Shaw, “A New Method for Brazing Nitinol Based on the Quasibinary TiNi—Nb System”, Structures, Structural Dynamics, and Materials and Co-located Conferences.” Apr. 23-26, 2007.
[2]. D. Suh and J. Weninger, “Multilayer preform for fast transient liquid phase bonding,” U.S. Patent Application Publication No. US2009/0004500A1, Jan. 1, 2009.
[3]. H. Mao, H.-L. Chen, and Q. Chen, “TCHEA1: A Thermodynamic Database Not Limited for ‘High Entropy’ Alloys,” J. Phase Equilib. Diffus., vol. 38, no. 4, pp. 353-368, August 2017.
[4]. J.-O. Andersson, T. Helander, L. Höglund, P. Shi, and B. Sundman, “Thermo-Calc & DICTRA, computational tools for materials science,” Calphad, vol. 26, no. 2, pp. 273-312, June 2002.
[5]. D. J. Fisher, Transient Liquid Phase Bonding. Materials Research Forum LLC, 2019.
[6]. W. D. MacDonald and T. W. Eagar, “Transient Liquid Phase Bonding,” Annual Review of Materials Science, vol. 22, no. 1, pp. 23-46, 1992.
[7]. A. M. Glaeser, “Transient liquid phase ceramic bonding,” U.S. Pat. No. 5,234,152, Aug. 10, 1993.
[8]. B. P. Barber, “Multilayered transient liquid phase bonding,” U.S. Pat. No. 11,546,998, Jan. 3, 2023.
[9]. E. J. Ryan, “Multiple foil transient liquid phase bonding,” U.S. Pat. No. 4,700,881, Oct. 20, 1987.
[10]. Shape Memory Alloys. vol. 1 (Springer US, Boston, MA, 2008).
[11]. J. P. Oliveira, et al., F. M., Prog Mater Sci 88, 412-466 (2017).
[15]. M. T. Tolley, S. M. Felton, S. Miyashita, D. Aukes, D. Rus, and R. J. Wood, “Self-folding origami: shape memory composites activated by uniform heating,” (in English), Smart Mater Struct, vol. 23, no. 9, September 2014.
[16]. T. Kirk, E. Galvan, R. Malak, and R. Arroyave, “Computational Design of Gradient Paths in Additively Manufactured Functionally Graded Materials,” (in English), J Mech Design, vol. 140, no. 11, November 2018.
[17]. M. Allen, T. Kirk, R. Malak, and R. Arroyave, “A Subspace-Inclusive Sampling Method for the Computational Design of Compositionally Graded Alloys,” (in English), J Mech Design, vol. 144, no. 4, Apr. 1, 2022.

1-14. (canceled)

15. A method of joining materials, comprising:
determining a composition path from a composition of one of a first base material and a second base material to be joined to each other to that of the other of the first base material and the second base material that avoids brittle or non-solid phases;
dividing the composition path into a series of segments such that a combination of phases along a segment is a subset of the phases present in the two end points of the segment;
identifying an anchor region that is the collection of the segments excluding two segments that join to the first and second base materials, respectively, wherein the anchor region comprises at least one anchor layer, configured to form a favorable composition gradient between the first and second base materials;
forming an assembly comprising an interlayer sandwiched between the first and second base materials, wherein the interlayer comprises at least two pre-liquid composition layers and the at least one anchor layer alternatively disposed between the at least two pre-liquid composition layers; and
performing transient liquid phase (TLP) bonding process on the assembly, during which a TLP reaction takes place joining the anchor layers to one another and the first and second base materials, thereby resulting in a joint with the favorable composition gradient and robust mechanical properties.

16. The method of claim 15, wherein the composition path is determined using thermodynamic calculations to predict thermodynamic equilibrium phases of compositions linking the composition of the one of the first base material and the second base material to that of the other of the first base material and the second base material, and identify the favorable composition gradient that yields the joint with high strength and no brittle phases.

17. The method of claim 15, wherein said determining the composition path is performed at an isothermal bonding temperature.

18. The method of claim 15, wherein the segments of the anchor region are fabricated as solid layers and joined together via the TLP reaction.

19. The method of claim 15, wherein the compositions between adjacent anchor layers reside in phase regions that are adjacent to regions with the same set of phases plus a common liquid phase.

20. The method of claim 15, wherein each segment end point is made into an individual anchor layer of that single composition, and in between anchors are a layer of the composition corresponding the common liquid phase for the given anchor layer pair.

21. The method of claim 15, wherein a single anchor layer of the entire gradient of the anchor region is used, and on either side of it is a layer whose composition corresponds to the liquid common between the anchor region endpoint and the corresponding base material composition.

22. The method of claim 15, wherein the at least one anchor layer comprises one of
a graded anchor layer having a composition gradient along its thickness;
a single anchor layer having a unform composition distribution along its thickness; and
multiple discrete anchor layers, each of which comprises a distinct composition.

23. The method of claim 22, wherein each anchor layer is disposed between two adjacent pre-liquid composition layers.

24. The method of claim 15, wherein said performing the TLP bonding process on the assembly comprises:
heating the assembly to a bonding temperature so that the at least two pre-liquid composition layers melt and form a liquid that is in equilibrium with terminal compositions of adjacent anchor layers;
holding the heated assembly for sufficient time to allow a transient liquid phase (TLP) reaction to occur and isothermally solidify therein, until the isothermal solidification has reached completion; and
cooling the solidified assembly back to room temperature to achieve a robust joint between the base material and the second base material, without formation of deleterious phases,
wherein the at least one anchor layer remains solid throughout the TLP bonding process.

25. (canceled)
